(19) United States
(12) Patent Application Publication
(10) Pub. No.: US 2011/0134246 A1
(43) Pub. Date: Jun. 9, 2011

(54) METHOD AND DEVICE FOR DEFLECTING EAVESDROPPING ATTEMPTS IN IMAGE DATA TRANSFER AT A SELF-SERVICE TERMINAL

(75) Inventors: Carsten Von Der Lippe, Paderborn (DE); Dinh Khoi Le, Paderborn (DE)

(73) Assignee: WINCOR NIXDORF INTERNATIONAL GMBH, Paderborn (DE)

(21) Appl. No.: 13/058,607

(22) PCT Filed: Aug. 20, 2009
(86) PCT No.: PCT/EP09/60774

§ 371 Date: Feb. 11, 2011

(30) Foreign Application Priority Data
Aug. 26, 2008 (DE) 10 2008 039 689.3

(51) Int. Cl. H04N 7/18

(52) U.S. Cl. 348/150; 348/E07.085

(57) ABSTRACT

A method and a device (DET) are proposed to defend against electronic spying during the transmission of image data (Sb) or image signals (Sa) that are generated by a camera (CAM) installed at a self-service terminal (ATM), said camera recording an area (A0) that covers an operating area of the self-service terminal (ATM). As soon as events occurring at the self-service terminal (ATM) in the recording area (A0) or outside of said area, in particular actuation of a key pad (KBD) and/or insertion of a card into a card slot (SLT), are detected, the generation of the image signals (Sa) and/or the transmission of the image data (Sb) is controlled as a function thereof, for instance at least the sensitive areas or partial image data (Sb′) in the image data obtained (Sb) are blanked out or replaced by artificially generated data.

### CROSS-REFERENCE TO RELATED APPLICATIONS

This application is a National Stage of International Application No. PCT/EP2009/060774, filed Aug. 20, 2009. This application claims the benefit and priority of German application 10 2008 039 689.3 filed Aug. 26, 2008. The entire disclosures of the above applications are incorporated herein by reference.

### BACKGROUND

This section provides background information related to the present disclosure which is not necessarily prior art.

The invention relates to a method to defend against attempted electronic spying when transmitting image data that are obtained from image signals generated by a camera installed at a self-service terminal. The invention also relates to a device to carry out the method and a self-service terminal.

1. Technical Field

The invention relates in particular to a method and a device to defend against attempted electronic spying when transmitting image data at a self-service terminal that is configured as an automated teller machine, wherein a camera records an area that covers an operating area of the self-service terminal, or the automated teller machine, that is to be monitored.

2. Discussion

It is known to secure self-service terminals, in particular automated teller machines, through camera monitoring in order to determine criminal acts, such as material damage and/or manipulation at the terminals and to record image material as material proof and for analysis. For this purpose, at least one camera is installed at the self-service terminal in question. This camera then continuously provides image signals from which normally digital image data are obtained that are transmitted to an image data memory and remote computers or servers in order to be evaluated there. Terminals in the form of automated teller machines in particular are the subject of such camera monitoring. Typical manipulation of automated banking machines is the installation of what are termed skimming devices. Dishonest parties install counterfeit keypads and/or card readers in the operating area of the automated teller machines in order to gain access to sensitive data, in particular card data and PINs. Recently, attack scenarios in the form of electronic spying attacks or attempted eavesdropping have become more frequent in which the dishonest parties want to gain access to the image signals generated by the camera, or the image data obtained from said signals, by capturing the transmission of these image signals, or image data (known as “tapping”), at the corresponding transmission lines. If such a spying attack is successful, the dishonest party can draw conclusions about the PIN entered by a customer and, possibly, read the card data when the card is inserted into the card slot. In this way, the dishonest party can gain access to the sensitive data without the use of special skimming devices.

### SUMMARY OF THE INVENTION

It is the object of the invention is to propose a method and a device to provide an effective defense against electronic spying attempts during the transmission of image data at a self-service terminal. In particular, a method, a device and a service terminal thus equipped are to be proposed that secure and protect the transmission of image data against such attempts at electronic spying.

Accordingly, it is proposed that events occurring at the self-service terminal, particularly in the recording area of the camera but also outside said area, are detected, and that, as a function of at least one detected event, the generation of the image signals at the camera and/or the subsequent transmission of the image signals, or the image data acquired, is controlled. Accordingly, an event is detected that represents, for example, the actuation of the keypad and/or the introduction of a card into the card slot in order to control, as a function thereof, the generation, or transmission, of the image signals and/or image data. Accordingly, the generation, or transmission of images is changed when an event is detected such as corresponds to sensitive operation of the self-service terminal. So, even in the event that lines and transmission routes are successfully tapped, the generation or transmission of corresponding sensitive image signals or image data can be prevented altogether. A wrongdoer who might possibly succeed in capturing the camera signals or the image data derived therefrom will not be able to obtain access to sensitive image signals or image data.

In accordance with the invention, a device to carry out the method is proposed that detects events occurring in the recording area of the camera by evaluating the image signals, the image data and/or sensor signals and, as a function thereof, controls the generation and/or transmission of the image signals, or image data.

Additionally, a self-service terminal equipped with such a device is proposed that can be specifically configured as an automated teller machine.

In a preferred embodiment, spying attempts are deterred by totally suppressing the generation of the image signals if at least one event is detected. Alternatively, the transmission of the image data obtained from the image signals generated is suppressed if at least one event is detected. Termination of the generation or transmission of image signals/data is time-controlled at least for as long as the sensitive event is detected. As another alternative to this, at least partial image data are blanked out in the image data acquired or replaced by artificially generated data if at least one event is detected. In this context, preferably those partial image data are involved that refer to at least one partial area of the recording area, in particular that refer to a first and second partial area that cover a keypad, or card slot in the operating area of the self-service terminal.

The events that are detected in particular in the operating area within the recording range of the camera or even outside said area are, for example, operation of a keypad or insertion of a card. The events in the recording area of the camera can be detected by evaluating the image signals and/or the image data. This can be done in the inventive device. As an alternative or in addition to this, the events can be detected by evaluating at least one sensor signal that is generated by a sensor for monitoring an operating element in the operating area of the self-service terminal, also outside the recording area of the camera. In addition, events such as the insertion of a card can be derived from the current status of the self-service terminal, in particular by querying or reading process states or state machines or similar. Appropriate signals can then be sent to the inventive device.

### BRIEF DESCRIPTION OF THE DRAWINGS

The drawings described herein are for illustrative purposes only of selected embodiments and not all possible implementations, and are not intended to limit the scope of the present disclosure.

The invention and the advantages resulting therefrom are described in what follows from one embodiment and with reference to the appended schematic drawings:

FIG. 1 shows schematically the operating area of a self-service terminal and a camera monitoring the operating area;

FIG. 2 shows as a block diagram components of the device to defend against spying attempts during the transmission of image data; and

FIG. 3 shows the flow chart of a method in accordance with the invention to defend against spying attempts during the transmission of image data.

### DESCRIPTION OF THE PREFERRED EMBODIMENTS

Corresponding reference numerals indicate corresponding parts throughout the several views of the drawings.

Example embodiments will now be described more fully with reference to the accompanying drawings.

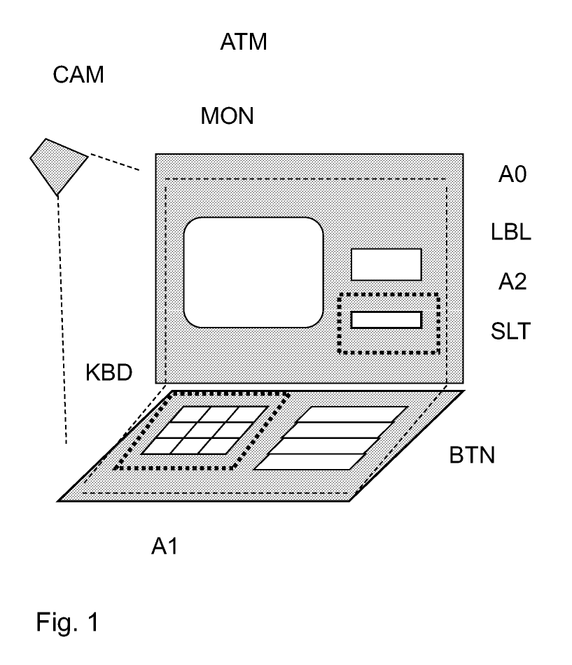

FIG. 1 shows the operating area of a self-service terminal that is configured here as an automated teller machine ATM, wherein the operating area includes the following operating elements: a keypad KBD to enter numbers, specifically PIN numbers, several functional buttons BTN, specifically to confirm keypad entries, a monitor MON to display operating information and a card slot SLT to insert cards, in particular bank cards. In addition, the operating area has additional fields, for example, signs and labels LBL. The operating area is monitored by at least one camera CAM located at the operating area, wherein the camera CAM has a recording area A0 which covers the entire operating area.

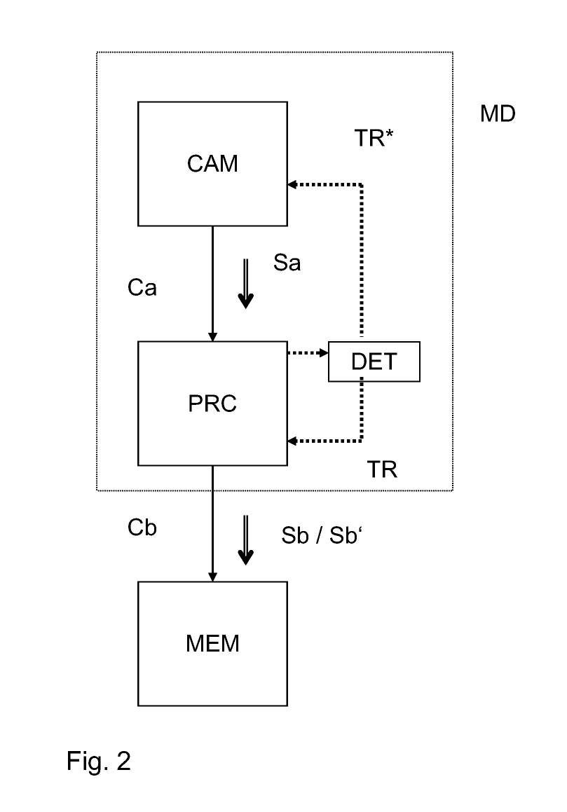

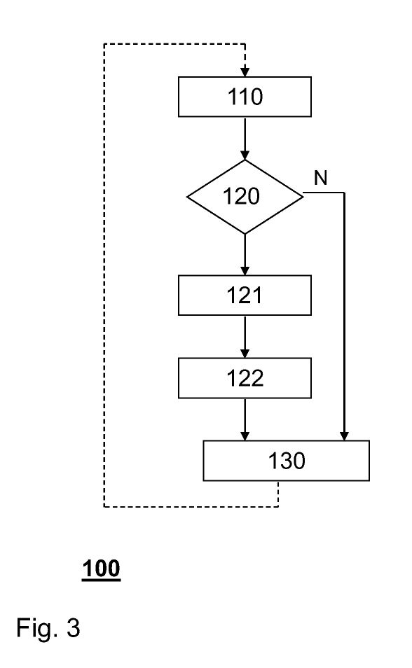

In accordance with the invention, during the transmission of the image signals or image data specific partial areas A1 and/or A2 are blanked out by means of the method described hereinafter and the corresponding device if a sensitive event is detected corresponding, for example, to the entry of PIN numbers or the insertion of a card. The hidden partial areas A1 and A2 refer in particular to sensitive areas of the recording area A0, here, as an example, the area A1 which covers the keypad KBD and the area A2 which covers the card slot SLT. Using FIGS. 2 and 3, the method in accordance with the invention and the device operating accordingly will be described in greater detail:

FIG. 2 shows as a block diagram the structure of an inventive device that is specifically configured as a detection unit DET and is connected to at least one image processing unit PRC, which receives the image signals Sa generated by the camera CAM and processes said signals. The image processing unit PRC generates digital image data Sb corresponding to the image signals Sa and transmits said data, for example, to a memory device MEM. This memory device can be located in a server remote from the self-service terminal. A first connection Ca is located between the camera CAM and the image processing unit PRC over which the image signals are transmitted. This connection Ca is, for example, an analog connection in the form of a coaxial cable which transmits corresponding image signals in the form of video signals from the camera to the image processing unit. The camera CAM and the image processing unit PRC are preferably integrated in one module MD so that third parties do not have direct access to the connection Ca in order to undertake attempts at eavesdropping.

Between the image processing unit PRC and the external memory MEM there is a second connection Cb over which the digital image data generated Sb or, in the case of a sensitive event in accordance with the invention, the altered digital image data Sb′ are transmitted. This connection Cb thus represents a secure digital data transmission connection that can extend as far as remote computers (servers), for example over data or communication networks such as IP connections. The image data transmitted Sb or Sb′ are then buffered on the receiving end in the memory MEM there and then fed to a data display and/or evaluation in order to evaluate the images captured by the camera.

This second connection Cb in particular offers a potential point of attack for spying attempts as third parties attempt to tap this connection. As a defense under the invention at least the transmission of the digital image data Sb or Sb′ is controlled in such a way that no image data are transmitted that could reproduce sensitive procedures or events, such as keypad entries or the insertion of a bank card. The control is carried out in accordance with the inventive method that is described hereinafter using FIG. 3.

FIG. 3 shows the flow chart for a method 100 having the steps 110 to 130. In a first step, the camera CAM acquires images and generates corresponding image signals Sb (see also FIGS. 1 and 2). Digital image data Sb are generated in the image processing unit PRC from these analog image signals. Then in a step 120, it is determined through evaluation of the image data generated whether an event exists that could affect the operation of sensitive areas in the operating area. For example, using the evaluation of image data Sb, it is detected that a person is using the keypad KBD in the operating area of the automated teller machine ATM. It can be additionally detected whether a person is inserting a bank card into the card slot SLT. If this is the case, a trigger signal TR (see FIG. 2) follows in a step 121 that controls the generation or transmission of the image data to the effect that at least partial image data are blanked out or replaced that affect the aforementioned sensitive image areas A1 or A2.

In a following step 122, the image data Sb′ are transmitted wherein the sensitive image data have been replaced by artificially generated data (dummy data). In a following step 130, transmission of the altered image data Sb′ is carried out over the second connection Cb.

However, if it was determined in step 120 that no event is present, transmission of the original image data Sb, that is to say transmission of the unaltered image data, takes place in accordance with step 130. This measure ensures that secure monitoring of the self-service terminal, or automated teller machine ATM, can be performed as before but that in the case of events that are sensitive, corresponding image data are not generated or transmitted.

In a simple embodiment, for the event that a sensitive event is detected the device DET can also generate a trigger TR* that directs the camera CAM directly to suppress completely the generation of the image signal Sa. In this case the entire image is suppressed.

The detection of events can not only take place through evaluation of the image signals Sa, or the image data Sb derived therefrom, but, as an alternative or in addition, by using sensor signals. In this case, the device DET is connected to sensors that are mounted on the sensitive operating elements, such as the keypad KBD and/or the card slot SLT. In a simple case, the sensor can be the respective button on the keypad itself or a detector at the opening of the card slot SLT.

A camera of normal construction can be used as the camera CAM which takes analog or digital images. The first connection Ca, for example, can be realized as a coaxial cable for analog image signals or, for example, as a USB cable for digitalized image signals, or image data. Image processing takes place in the image processing unit PRC which can be implemented, for example, as specific electronics or as a software program that runs on a personal computer. The processed image, or the image data obtained, are then forwarded over the second connection Cb to the memory MEM, or to a remote computer, in particular to a server that evaluates the image data further, or brings them up on a display. The server can be located, for example, in a monitoring center that monitors several self-service terminals simultaneously.

Besides the measures already described, the transmitted image signals Sa or Sb can additionally be encrypted in order to be secured even more thoroughly against third party spying attempts. Preferably the camera CAM and the image processing unit PRC form one structural unit in the form of a module MD. As has been described above, those areas of the image are blanked out and/or it is made clear in the image processing from which ones conclusions can be drawn about the PIN entry or about card data. Altering the image data can take the form of setting all pixels in the partial areas mentioned to the same color and/or brightness, for example.

Control of the generation of image signals or transmission of the image data is time-dependent as the blanking out of image data is carried out only at such times as an event is detected. This ensures that no sensitive or critical procedures, such as the entry of PIN number or insertion of cards, are recorded and/or transmitted. The determination of the blanked out or altered partial image data areas can also be further developed in such a manner that only specific partial areas such as writing and number information on bank cards is blanked out or overwritten. The defense against spying attempts can be undertaken in such manner that by means of a trigger the image is completely terminated. This happens, for example, as soon as a hand or finger is positioned over the pin pad KBD and thus a conclusion can be drawn about the process of a PIN entry. The detection of such a situation can be carried out through image recognition techniques by means of which, for example, the appearance of a hand or fingers in the recording area, in particular in the area of the keypad KBD, or the insertion of a bank card in the card slot SLT are detected.

Further, in order to check whether a sensitive event exists, additional information can be brought in besides sensors that is usually available in a self-service terminal. This is, for example, the current status regarding the condition of the self-service terminal. For example, the hand only needs to be masked in the image when entering a PIN number if a PIN number is actually entered. On the other hand, no masking in necessary if the hand is only performing a menu prompt. No masking is necessary either as long as there is a magnetic or chip card in the system.

The proposed invention effectively prevents any spying attack on the transmission of camera signals or image data at a self-service terminal.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A method to defend against attempted electronic spying during the transmission of image data that are obtained from image signals generated by a camera installed at a self-service terminal, comprising wherein the camera records an image area that covers an operating area of the self-service terminal to be monitored, comprising wherein events occurring at the self-service terminal are detected and in that the generation of the image signals and/or the transmission of the image data is controlled as a function of at least one detected event.

2. The method from claim 1, wherein events at the self-service terminal in the operating area, in particular within the recording area of the camera, and/or outside of said area are detected.

3. The method from claim 1, wherein the actuation of a keypad in the operating area of the self-service terminal is detected as an event.

4. The method from claim 1, wherein the insertion of a card into a card slot in the operating area of the self-service terminal is detected as an event.

5. The method from claim 1, wherein the generation of the image signals is prevented when at least one event is detected.

6. The method from claim 1, wherein the transmission of the image data obtained from the image signals generated is prevented when at least one event is detected.

7. The method from claim 1, wherein at least partial image data (Sb′) in the image data obtained are blanked out or replaced with artificially created data when at least one event is detected.

8. The method from claim 7, wherein the partial image data (Sb′) refer to at least one partial area (A1, A2) of the recording area, in particular to a first and/or second area (A1, A2) that covers a keypad and/or a card slot in the operating area of the self-service terminal.

9. The method from claim 1, wherein the events are detected by evaluating the image signals and/or the image data.

10. The method from claim 1, wherein the events are detected by evaluating at least one sensor signal that is generated by a sensor for monitoring an operating element in the operating area of the self-service terminal.

11. The method from claim 1 wherein to control the generation of the image signals and/or the transmission of the image data at least one trigger signal is generated when an event is detected.

12. A device (DET) to defend against electronic spying during the transmission of image data that are obtained from image signals that a camera installed at an self-service terminal generates, wherein the camera records an area that covers an operating area of the self-service terminal to be monitored comprising wherein the device receives signals about events occurring at the self-service terminal and/or detects events occurring in the recording area by evaluating the image signals, the image data and/or sensor signals and, as a function of at least one event detected, controls the transmission of the image data.

13. The device (DET) from claim 12, wherein the device is connected to the camera and/or to an image processing unit that generates or derives the image data from the image signals.

14. A self-service terminal having a device to defend against electronic spying during the transmission of image data which are obtained from image signals generated by a camera installed at the self-service terminal, wherein the camera records an area that covers an operating area of the self-service terminal to be monitored, comprising wherein the device receives signals about events occurring at the self-service terminal and/or detects events occurring in the recording area by evaluating the image signals, the image data and/or sensor signals and, as a function of at least one event detected, controls the generation of the image signals and/or the transmission of the image data.

15. The self-service terminal from claim 14, wherein the self-service terminal has an image processing unit connected to the camera over a first connection which generates or derives the image data from the image signals.

16. The self-service terminal from claim 15, wherein the image processing unit transmits the image data over a second connection to an internal or external data memory.

17. The self-service terminal from claim 13, wherein the camera and the image processing unit are integrated in one module.

18. The self-service terminal from claim 13, wherein the self-service terminal is configured as an automated teller machine that has an operating area with a keypad and/or a card slot.
